(19) United States
(12) Patent Application Publication
(10) Pub. No.: US 2026/0093908 A1
(43) Pub. Date: Apr. 2, 2026

(54) PROMPT TEMPLATE EXTENSIBILITY

(71) Applicant: SAP SE, Walldorf (DE)

(72) Inventor: Manikandan RAJASEKAR, Bangalore (IN)

(21) Appl. No.: 18/903,800

(22) Filed: Oct. 1, 2024

(51) Int. Cl. G06F 40/186

(52) U.S. Cl. CPC G06F 40/186

(57) ABSTRACT

Systems and methods include identification of a prompt template associated with a text generation model and conforming to a prompt template schema, reception of instructions to edit the prompt template, generation, in response to the instructions, of an extended prompt template, determination of an extension rule associated with the prompt template, determination that the extended prompt template satisfies the extension rule, and, in response to the determination that the extended prompt template satisfies the extension rule, activation of the extended prompt template for use with the text generation model.

### BACKGROUND

Modern database systems store vast amounts of data for their respective enterprises. Software applications are employed to access this stored data in order to perform various functions. These functions are increasingly provided via integration with neural networks, or machine learning models. The machine learning models may include, for example, custom models trained on private data or publicly available Large Language Models (LLMs). By leveraging the predictive algorithms of these models, a software applications may suggest inputs, predict numerical and/or textual values, generate summaries, descriptions, reports and emails, and recommend next steps or actions.

Due to the difficulty of selecting, training and using machine learning models, software applications typically hide their usage of such models from end users. For example, a user may therefore invoke a function for generating a predicted value without knowing the details or existence of a trained regression model which will be used to infer the predicted value. Similarly, a user may utilize a function to draft an e-mail without awareness of a prompt template or an LLM which are employed to execute the function.

Some applications may be customized and extended to conform to the particular data models and process requirements of an organization. To maximize application usefulness, the functions provided by the applications should be compatible with these customizations and extensions. In the case of LLM-enabled functions, the standard prompt templates should be modifiable to conform to the customizations and to leverage the extensions.

An organization's users cannot easily modify a standard prompt template without disrupting the integration between the application, the template, and an LLM for which the template is intendeds. Systems are desired to facilitate modification of standard prompt templates used by an application without requiring expert knowledge of LLMs or associated programming patterns.

### BRIEF DESCRIPTION OF THE DRAWINGS

FIG. 1 is a block diagram of an architecture to edit and use prompt templates according to some embodiments.

FIG. 2 is a modelling diagram relating to prompt templates according to some embodiments.

FIG. 3 is a block diagram of a prompt extension management component according to some embodiments.

FIGS. 4A and 4B comprise a flow diagram of a process to create an edited prompt template according to some embodiments.

FIG. 5 is a user interface of a scenario manager application presenting scenarios according to some embodiments.

FIG. 6 is a user interface of a scenario manager application presenting a model and prompt templates of a scenario according to some embodiments.

FIG. 7 is a user interface of a prompt template editor window of a scenario manager application according to some embodiments.

FIG. 8 is a user interface of a scenario manager application presenting a model and prompt templates of a scenario according to some embodiments.

FIG. 9 is a block diagram of a hardware system providing editing and use of prompt templates according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments provide a framework for extending pre-defined prompt templates for use by a software application. The templates may be extended with minimal effort and without disrupting the integration between the application and the inference consumption. The framework includes a prompt template schema to which non-extended and extended prompt templates conform, and an extension rule schema for defining extension rules. A prompt template may be associated with one or more extension rules that specify allowed modifications to the prompt template.

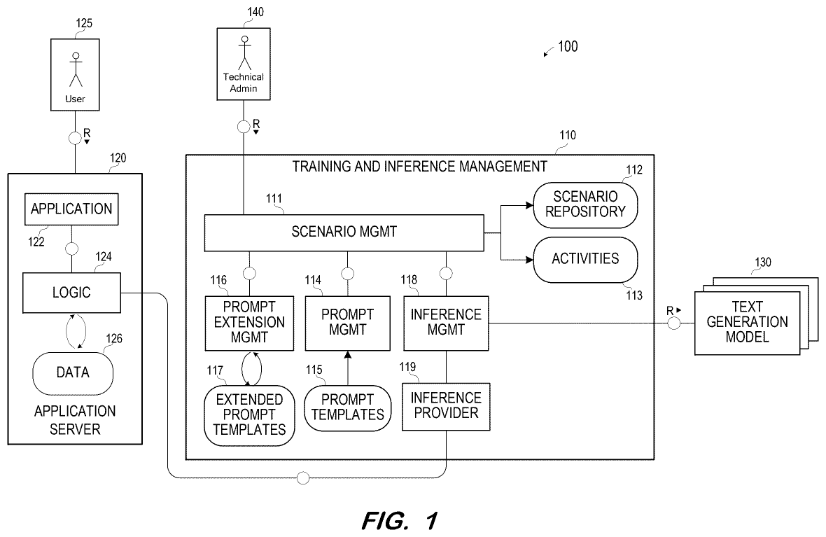

FIG. 1 is a block diagram of an architecture of system 100 to edit and use prompt templates according to some embodiments. The illustrated elements of system 100 may be implemented using any suitable combination of computing hardware and/or software that is or becomes known. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service). Such implementations apportion computing resources elastically according to demand, need, price, and/or any other metric.

Training management service 110 includes scenario management component 111 and scenario repository 112. Scenario management component 111 allows a technical administrator (e.g., a key user) operating technical administrator system 140 to define and modify machine-learning scenarios stored in scenario repository 112. Scenario management component 111 may also associate a machine-learning scenario with an application in order to enable end-users of the application to request inferences from a trained model based on the scenario.

A machine-learning scenario may specify a “classical” model (e.g., a classification model, a regression model), training data, validation data, a training pipeline, and an inference pipeline. On the other hand, a machine-learning scenario may specify a text generation model (e.g., an LLM), a system prompt template, a user prompt template, one or more extended prompt templates, and an inference pipeline. Training management service 110 may include unshown components for managing training and inference with respect to classical machine learning models.

Prompt management component 114 may be accessed to associate prompt templates 115 with scenarios, to view prompt templates 115 which are associated with scenarios, to activate prompt templates 115, and to initiate extension of prompt templates 115. Prompt templates 115 include system prompts and user prompts which are usable to describe a text response that is desired from the text generation model. A system prompt may comprise a set of instructions to constrain the realm, task, context, style, etc. of the response. A user prompt may specify a query to be answered by the response. Either or both of a system prompt and a user prompt may include placeholders for inserting data associated with a specific inference situation that employs the system prompt/user prompt.

Each of prompt templates 115 and extended prompt templates 117 consists of prompt text, accompanying metadata, references to other data within applications, formatting rules, etc. A prompt template is structured in a declarative model conforming to a prompt template schema as will be described below. Prompt templates 115 may be provided as standard components to all tenants of training and inference management component 110 and are activated by default for use in machine-learning scenarios.

Each of extended prompt templates 117 is a modified version of one of prompt templates 115. Several of extended prompt templates 117 may be modified versions of the same prompt template 115. Each extended prompt template 117 is associated with specific identifiers and “status” metadata, enabling administrators to maintain multiple versions of extended prompt templates 117 and facilitate the activation of a chosen version for consumption within the system.

Each of extended prompt templates 117 conforms to extension rules associated with the prompt template 115 on which the extended prompt template 117 is based. The extension rules ensure that extended prompt templates 117 conform to the template schema and generate model responses which are functionally equivalent to responses generated by the prompt templates 115 on which the extended prompt templates 117 are based. These features allow efficient deployment of extended prompt templates 117 while maintaining operational continuity with standard configurations.

Application server 120 may comprise an on-premise or cloud-based server providing an execution platform and services to applications such as application 122. Application 122 may comprise a user interface application providing functions to users based on coded logic 124 and data 126. Data 126 may be stored in any suitable storage system such as a database system, which may be partially or fully remote from application server 120. Logic 124 may create, read, update and delete data of data 126 based on a data schema consisting of semantic objects as is known in the art. For instance, data 126 may comprise relational database tables and views whose columns conform to a data schema defined by metadata stored in data 126. The data schema may define a SalesOrder object type and data 126 may comprise data associated with each of many specific sales orders.

A user may operate user device 125 to interact with application 122. User device 125 may comprise but is not limited to a laptop computer, a desktop computer, a smartphone, and a tablet computer. User device 125 includes one or more processing units to execute program code of a Web browser or another application providing user interfaces for interacting with application 122. The user interface may comprise a front-end user interface application corresponding to application 122 and which executes within a virtual machine of a Web browser to communicate with application 122 and present user interfaces thereof. The communication may comprise a request for an inference based on a machine-learning scenario provided by management component 110 and associated with application 122.

Logic 124 may request such an inference from inference provider 119. In response, inference management component 118 selects, based on the scenario, an appropriate model from text generation models 130 and appropriate prompt templates from prompt templates 115 or extended prompt templates 117. Inference management component 118 populates the selected prompt templates as needed with data received in the inference request, transmits the resulting prompts to the selected text generation model 130 through remote APIs, and receives text responses in return. To improve reliability, inference management component 118 may incorporate retry mechanisms, timeout handling, and failover protocols.

Each of text generation models 130 may comprise a neural network trained to generate text based on input text. A text generation model 130 may be implemented by, for example, executable program code, a set of hyperparameters defining a model structure and a set of corresponding weights, or any other representation of an input-to-output mapping which was learned as a result of the training. According to some embodiments, each text generation model 130 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of text generation models 130 include GPT-4, LaMDA, Claude or the like. Models 130 may be publicly available or deployed within a landscape which is trusted by a provider of application server 130. Similarly, text generation models 130 may be trained based on public and/or private data.

Scenario management component 111 may store prompt template usage history in activities 113. The history may include detailed usage metrics and user feedback analytics. A technical administrator may access activities 113 to analyze how prompt templates are utilized over time, to rank prompt templates based on performance metrics and user feedback, to prioritize the use of more effective prompt templates, and to block specific usage of prompt templates which are deemed ineffective or present other issues.

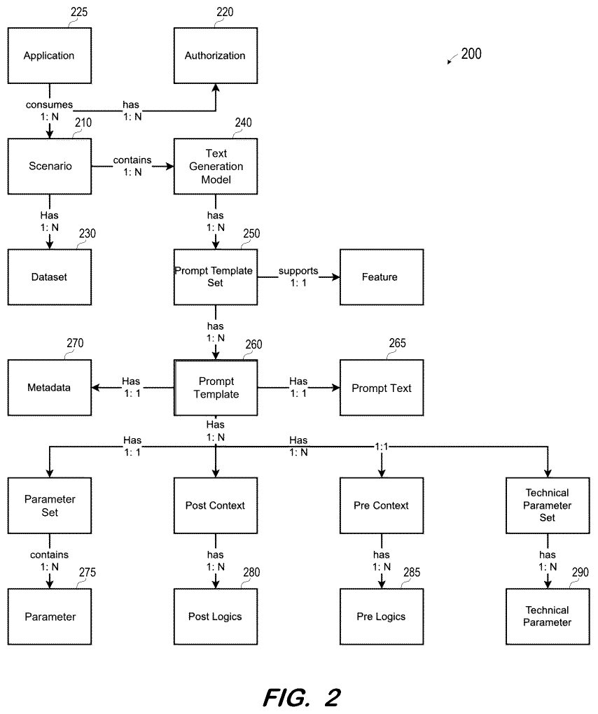

FIG. 2 shows modelling diagram 200 relating to prompt templates according to some embodiments. Diagram 200 includes scenario entity 210 representing a machine-learning scenario and illustrates its references to and relationships with other entities. For example, a scenario entity 210 is associated with one or more authorization entities 220 which specify authorizations required to view and deploy the scenario entity 210. A technical administrator associated with a suitable authorization may deploy the scenario entity 210 for consumption by one or more application entities 225.

Dataset entities 230 may comprise database tables linked to specific scenario entities 210, providing references for accessing pertinent data throughout various stages of lifecycle management. The data of a dataset entity 230 may be used to populate prompt templates associated with a given scenario. Dataset entities 230 facilitate data-driven decision-making and operational processes within the framework.

Each scenario entity 210 is associated with one or more text generation model entities 240. In turn, each text generation model entity 240 is associated with one or more prompt template set entities 250. A prompt template set entity 250 comprises a collection of one or more prompt template entities 260 which are related to a specific activity/topic/etc. A prompt template entity 260 is associated with a prompt text entity 265 and a metadata entity 270. A metadata entity 270 may include version and authorization information, for example.

A prompt template entity 240 is associated with one or more parameter entities, one or more post logic entities 280, one or more pre logic entities and one or more technical parameter entities 290. The entities associated with a prompt template entity 260 may be specified according to a prompt template schema. According to some embodiments, all prompt template entities 260, including extended prompt templates, conform to the same prompt template schema. Appendix A includes a prompt template schema according to some embodiments. In this regard, Appendix B includes an example of a prompt template conforming to the prompt template schema of Appendix A.

According to some embodiments, administrators are permitted to extend only specific sections of a prompt template. Some embodiments allow extension of the prompt template metadata, authorization roles, semantics, pre-context logic, post-context logic, datasets, parameters, technical parameters, and prompt text. By allowing extensions to these specific sections, prompt templates may remain secure, effective, and customizable, thus balancing flexibility with stringent security measures.

Regarding extensions to prompt template metadata, an administrator can update permissions for further extensions, update template transportability, and add authorization roles, including application-specific authorization roles. An administrator may modify the semantics of a prompt template to change its tone, reconfirmation, level of formality, etc. An administrator can add further pre-context validations and instructions, enhancing a template's robustness before execution. Similarly, post-context validations and instructions may be added to the template, ensuring thorough processing after initial execution.

Regarding datasets of a prompt template, additional database objects may be introduced, such as tables and views that are part of embedded extensions of an application side. Accordingly, an administrator may append parameters to a prompt template, either technical parameters or parameters involving extension fields and additional custom fields of an extension database table. An administrator may also remove optional parameters that are no longer necessary.

The prompt text of a prompt template may also be modified, including the option to add new parameters to the prompt text. The placement of these or original parameters within the populated prompt during runtime can also be adjusted for optimal clarity and effectiveness.

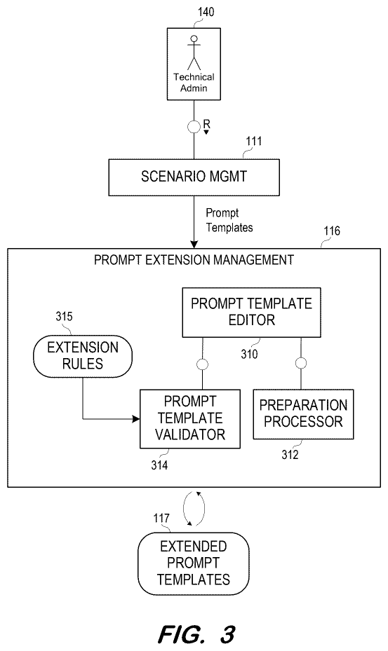

FIG. 3 is a block diagram of a prompt extension management component 116 according to some embodiments. Prompt extension management component 116 includes prompt template editor 310, preparation processor 312, prompt template validator 314 and extension rules 315

Prompt template editor 310 provides a user-friendly interface for modifying prompt templates. Each modification made to a prompt template is stored with an internal version number. Upon completion of the editing of a prompt template, an “activity”entity is created to facilitate tracking and meet audit requirements. Accordingly, every change to a prompt template is documented and traceable, maintaining transparency and accountability throughout the editing lifecycle.

Preparation processor 312 checks the authorization of the current user to access a prompt template based on authorization information within the prompt template. Preparation processor 312 also checks the authorization of the current user to edit the prompt template based on extension rules associated with the prompt template. Preparation processor 312 may also fetch activity data associated with the prompt template for presentation to the user.

Prompt template validator 314 checks whether an edited prompt template conforms to the prompt template schema. Prompt template validator 314 also identifies extension rules 315 associated with the original prompt template and confirms whether the edited prompt template meets the requirements of the identified extension rules 315. Extension rules 315 govern the extension of a prompt template and are also defined in a declarative language format specified by an extension rule schema.

Extension rules 315 may relate to data constraints, naming conventions, and specific references within the prompt template itself. Extension rules 315 may include mandatory rules which are applicable to all prompt templates and additional rules which are specific to a given prompt template. Examples of the mandatory rules include standardized naming conventions and references to essential datasets that must be adhered to for consistency and compatibility within the system. The additional rules are specific to a prompt template provider's policies or specific use cases, ensuring that extensions of their prompt templates meet their standards or operational requirements. The mandatory and additional extension rules ensure accommodation of standardized requirements and provider-specific considerations so as to maintain coherence and reliability in the extended prompt template ecosystem.

Each of extension rules 315 may include pre-context and/or post-context logic. The pre-context logic may determine whether an extended prompt template exhibits required characteristics, while the post-context logic may determine whether a populated extended prompt template exhibits required characteristics. Post-context logic may evaluate whether text returned by a text generation model in response to a populated extended prompt template satisfies certain requirements, for example, consistency with text returned in response to a populated prompt template on which the extended prompt template is based. Prompt template validator 314 may execute any pre-context or post-context logic during validation of an extended prompt template 117.

Appendix C includes an extension rule schema according to some embodiments, while Appendix D includes an example of an extension rule conforming to the extension rule schema of Appendix C.

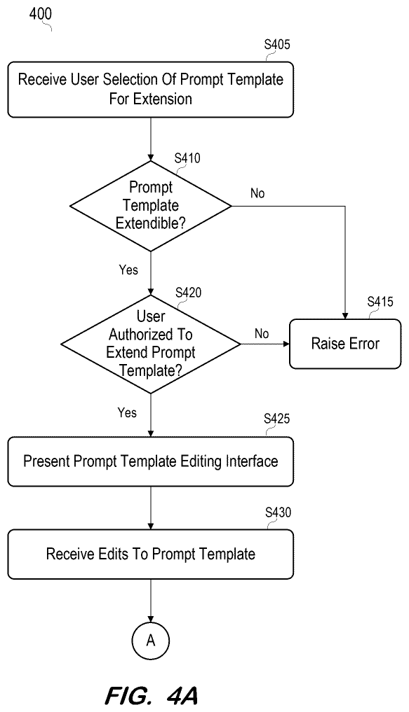

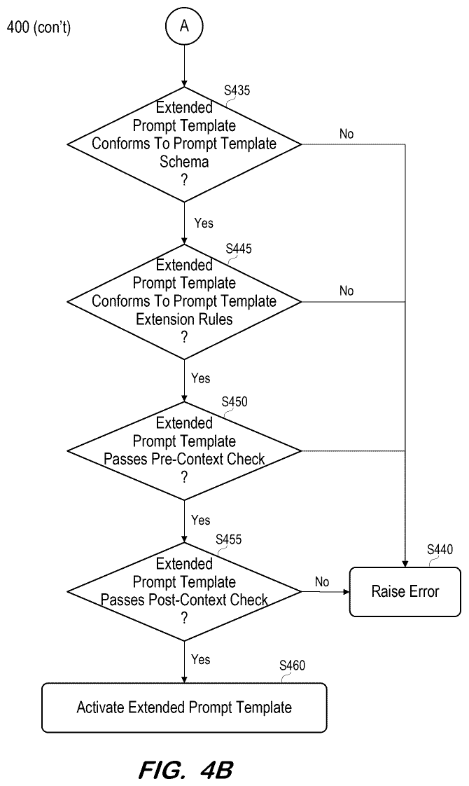

FIGS. 4A and 4B comprise a flow diagram of process 400 to create an edited prompt template according to some embodiments. Process 400 will be described with respect to the elements of system 100, but embodiments are not limited thereto.

Process 400 and all other processes mentioned herein may be embodied in processor-executable program code read from one or more of non-transitory computer-readable media, such as a hard disk drive, a volatile or non-volatile random-access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

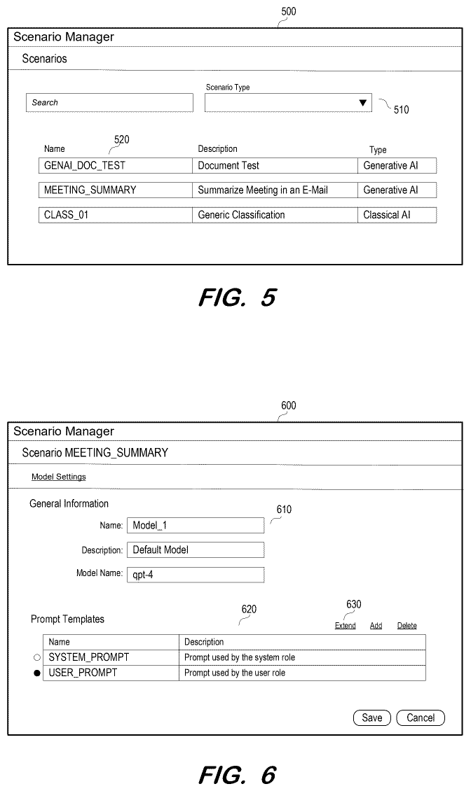

Initially, at S405, a user selection of a prompt template is received. The selected prompt template is a prompt template which is intended to be extended according to some embodiments. FIG. 5 illustrates user interface 500 of scenario management component 111 according to some embodiments. According to some embodiments of S405, technical administrator system 140 executes a Web browser to access scenario management component 111 via HyperText Transfer Protocol and receives user interface 500 in return. Embodiments are not limited to user interface 500.

Interface 500 includes input fields 510 for searching and/or filtering available machine-learning scenarios, such as scenarios stored in scenario repository 112. List 520 includes three machine-learning scenarios which are available for deployment. The listed scenarios meet the criteria specified in input fields 510 and are authorized for use by the current operator of technical administrator system 140. Selection of one of the listed scenarios results in display of interface 600 of FIG. 6.

Interface 600 includes information regarding a model associated with the selected scenario. As mentioned above, a scenario may be associated with one or more models. Fields 610 provide metadata of the model and list 620 identifies prompt templates associated with the model. As also mentioned above, a model may be associated with one or more pre-defined prompt templates 115 and with any number of extended prompt templates 117. List 620 of FIG. 6 displays two prompt templates 115, a system prompt template and a user prompt template.

Extend control 630 may be selected to extend a selected prompt template of list 620. According to the present example, prompt template USER_PROMPT is currently selected. Selection of extend control 630 therefore causes prompt template USER_PROMPT to be selected for extension at S405.

At S410, it is determined whether the selected prompt template is extendible. According to some embodiments, scenario management component 111 provides the selected prompt template to prompt extension management component 116 and preparation processor 312 determines whether the selected prompt template is extendible at S410. The determination may be based on the metadata of the prompt template, which may specify whether or not the prompt template is extendable. If not, an error is raised at S415.

If it is determined at S410 that the selected prompt template is extendible, flow proceeds to S420 to determine whether the current user is authorized to extend the prompt template. S420 may also be performed by preparation processor 312. Again, the prompt template may specify roles which are authorized to extend the prompt template. An error is raised at S415 if the current user is not authorized to extend the prompt template.

Flow proceeds from S420 to S425 if the current user is authorized to extend the prompt template. A prompt template editing interface of prompt template editor 310 is presented at S425. Next, at S430, edits to the prompt template are received via the presented interface.

FIG. 7 shows prompt template editing interface 700 according to some embodiments. Interface 700 includes general information 710 of the selected prompt template and text 720 of the prompt template. Text 720 may include placeholders “{parameter}” for parameter values as is known in the art. In some embodiments, interface 700 allows editing of text 720, including addition or deletion of parameter placeholders.

Parameters 730 of the prompt template include parameters Items, Source and Destination used in text 720. Interface 700 allows addition and deletion of parameters as well as editing of their respective default values (i.e., values used to populate text 720 if no corresponding value is available). Parameters 730 also include technical parameters Tone and Formality, whose default values may be adjusted via interface 700. Selection of Save control 740 causes any edits made to the prompt template via interface 700 to be saved to a new, extended, prompt template and received at S430.

Next, at S435, it is determined whether the extended prompt template conforms to the prompt template schema. The determination at S435 may be performed by prompt template validator 314. If the extended prompt template conforms to the prompt template schema, it is determined whether the extended prompt template conforms to extension rules associated with the prompt template at S445. The determination at S445 may also be performed by prompt template validator 314, in conjunction with extension rules 315. For example, prompt template validator 314 retrieves an extension rule 315 which is associated with the selected prompt template and then applies the retrieved extension rule 315 to the extended prompt template to determine whether the extended prompt template conforms to extension rules.

Flow proceeds to S450 if the extended prompt template conforms to the extension rules. At S450, prompt template validator 314 may execute any pre-context logic associated with the prompt template to determine whether the extended prompt template passes a pre-context check. Similarly, at S455, prompt template validator 314 may execute any post-context logic associated with the prompt template to determine whether the extended prompt template passes a post-context check.

Flow proceeds to S440 if any of the determinations at S435, S445, S450, or S455 are negative. If all of the determinations at S435, S445, S450, or S455 are positive, the extended prompt template is activated for use at S460. Activation of the extended prompt template may comprise associating the extended prompt template with the machine-learning scenario of the prompt template which was selected at S405. This association enables use of the extended prompt template within the machine learning scenario.

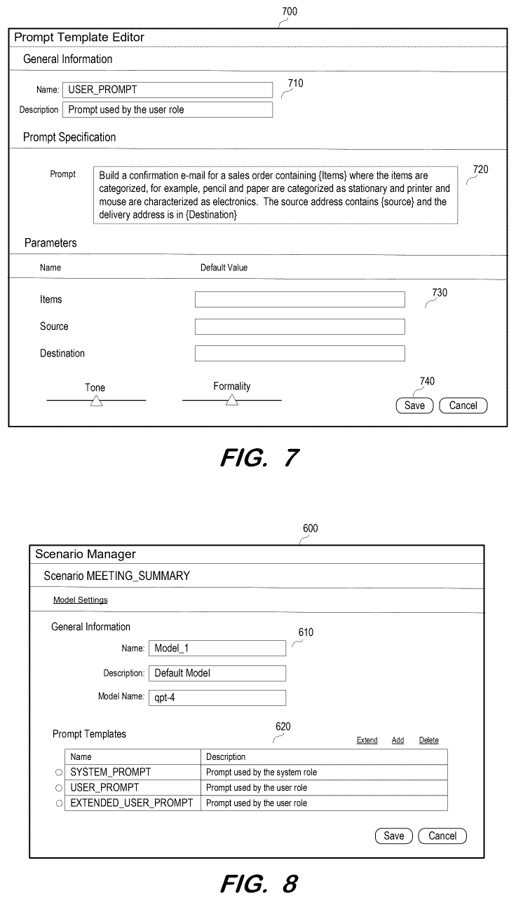

FIG. 8 illustrates user interface 600 after activation of an extended prompt template EXTENDED_USER_PROMPT at S460. The extended prompt template is associated with the scenario MEETING_SUMMARY and may be selected for use therein by the technical administrator. Accordingly, in response to a request from user system 125 for a “meeting summary”, inference management component 118 may populate the SYSTEM_PROMPT template and the EXTENDED_USER_PROMPT template and forward the populated templates to an associated text generation model 130.

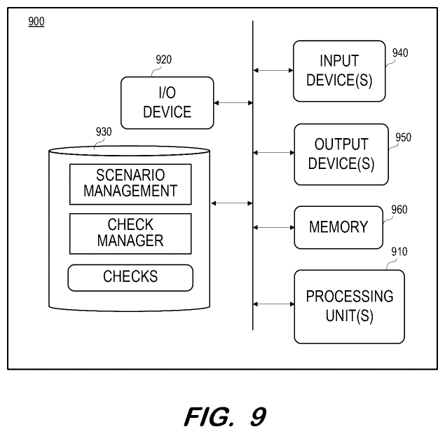

FIG. 9 is a block diagram of a hardware system providing training and inference management according to some embodiments. Hardware system 900 may comprise a general-purpose computing apparatus and may execute program code to perform any of the functions described herein. Hardware system 900 may be implemented by a redundant cloud-based server and may comprise an implementation of training and inference management system 110 in some embodiments. Hardware system 900 may include other unshown elements according to some embodiments.

Hardware system 900 includes processing unit(s) 910 operatively coupled to I/O device 920, data storage device 930, one or more input devices 940, one or more output devices 950 and memory 960. Communication device 920 may facilitate communication with external devices, such as an external network, the cloud, or a data storage device. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into hardware system 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, and RAM devices, while memory 960 may comprise a RAM device.

Data storage device 930 stores program code executed by processing unit(s) 910 to cause server 900 to implement any of the components and execute any one or more of the processes described herein. Embodiments are not limited to execution of these processes by a single computing device. Data storage device 930 may also store data and other program code for providing additional functionality and/or which are necessary for operation of hardware system 900, such as device drivers, operating system files, etc.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

### Appendix A

# Prompt Template Schema
api: com.sap.islm/v1
type: islm.PromptTemplate
id: {identifier}
# metadata of the prompt template
metadata:
# Name of the Prompt template
name: {string, mandatory:true}
# description for the template
description: {string}
# semantic version of the prompt template
version: {semantic version}
# when the prompt template is deplayed in the system
deployedOn: {datetime}
# status of the template
status: {string|released, depricated, obselete}
# is the templete allowed for extension
isExtensible: {boolean|default: false}
# is the template protected
protected: {boolean|default: false}
# required authorization for this template to edit, use etc
authRoles:
# name of the roles
—{string|reference to role names}
# associated LLM model metadata
model:
# name of the llm model
name: {string}
# type of the llm model
type: {string|llm_hypersclaer, fine_tunned}
# vendor of the model
vendor: {string}
# status of the model
status: {string}
# semantics of the template to be used for customization
semantic:
# specific tones
tone: {string|positive|informal|formal . . . }
# reconfirmation behaviour
reconfirmation: {boolean|efault: true}
# formality
formallity: {string|formal, informal, expert}
# evidence
evidence: {boolean|default: false}
# runtime information of the template
runtime:
# is it extended one?
extended: {boolean|default:false}
# if extended the root template reference?
rootTemplate: {string|identifier of previous root template}
# is it activated in the system
isActive: {boolean|default:false}
# is activated for all or specific segments
activate:
—{string|all, specific users, specific user groups}
# pre context of the template to be validated
preContext:
# text of the context
value: {string}
# assigned functions if any
functions:
# name of the function
—name: {string}
# type of the function—local or remote
type: {string|default: local}
# destination associated with remote function
destination: {string}
# business parameters used in the prompt text
bizParameters: {array of objects}
# name of the parameter
—name: {string|prompt text specific}
# type of the parameter
type: {string|int, string . . . }
# specific data base object references
reference: {string|dataset reference}
# can be filled by user in runtime?
fill: {boolean|default: false}
# technical parameters used in the prompt text
techParameters: {array of objects}
# name of the parameter
—name: {string|model specific}
# type of the parameter
type: {string|int, string, . . . }
# specific data base object references
reference: {string|dataset reference}
# can be filled by user in runtime?
fill: {boolean|default: false}
# involved reference data obejcts
dataset: {array of object}
# name of the data object
—name: {string|data base view/table}
# type of the data object
type: {string|view/table/.}
# runtime mapping of data
follow: {string|defaukt: cursor}
# actual prompt text in multiline
promptText:
# prompt text
—value: {string}
# post context of the template to be validated
postContext:
# text of the context
value: {string}
# assigned functions if any
functions:
# name of the function
—name: {string}
# type of the function—local or remote
type: {string|default: local}
# destination associated with remote function
destination: {string}

### Appendix B

# Prompt Template Example
api: com.sap.islm/v1
type: ISLM. PromptTemplate
id: “exttemple001”
metadata:
name: “SalesOrderSummaryTemplate”
description: “Template to summarize Sales Order”
version: 1.0.0.1
deployedOn: 03.12.2024 02:01:00
status: “Released”
isExtensible: true
protected: true
authRoles:
—“ISLM_BUSINESS_ANALYST: USE”
—“ISLM_BUSINESS_ANALYST: EXTEND”
model:
name: “gpt4.0”
type: “llm-hyperscaler”
vendor: “azure”
status: “published”
runtime:
extended: true
rootTemplate:
—name: “temple001”
isActive: false
activate:
—“all”
preContext:
value: “Provide response with Sales Representative view”
functions:
—name: “VALIDATE_PREREQUISTES”
type: local_function
bizParameters:
—name: salesOrderId
type: string
reference: $.SALESTAB.SID
—name: customerName
type: string
reference: $.SALESTAB.CUSTNAME
—name: details
type: string
fill: true
techParameters:
—name: maxToken
type: int
value: 2500
—name: temperature
type: int
value: 1
dataset:
—name: SALESTAB
type: data.table
—name: SALEINFOTAB
type: data.table
promptText:
value: “Generate a summary of sales order with details {$salesOrderId}, {salesOrderDetails}”
postContext:
value: “Reconfirm the reponse with confidence level”
functions:
—name: SECURITY_WHITELISTING_CHECKS
type: local_function

### Appendix C

# Extension Rule Schema
api: com.sap.islm/v1
type: islm.ExtensionRules
# immutable value to identify of the extension rule
id: {identifier}
metadata:
# name of the extension rule
name: {string}
# who is the provider of the extension rule
provider: {string|default: islm.framework}
# does it related to specific array of prompt templates
templates:
name: {identifier}
rule:
# which filed should be subjected ot the rule
enforce: {attribute reference in prompt template}
# array of rules to be applied
rule:
# name of the rule
name: {string}
# type of rule to be evaluate in runtime
type: {string|regx, local_function}

### Appendix D

# Extension Rule Example
api: com.sap.islm/v1
type: islm.ExtensionRules
id: “extenrule01”
metadata:
name: “extensionruleforpt01”
provider: islm.framework
rule:
enforce: $.islm.PromptTemplate.metadata.isExtensible
rule:
name: “CHECK_NAME”
type: local_function
—name: “[\hat{ }A-Za-z0-9_]”
type: regx

What is claimed is:

1. A system comprising:
a memory storing executable program code;
one or more processing units to execute the program code to cause the system to:
identify a prompt template associated with a text generation model and conforming to a prompt template schema;
receive instructions to edit the prompt template;
in response to the instructions, generate an extended prompt template;
determine an extension rule associated with the prompt template;
determine that the extended prompt template satisfies the extension rule; and
in response to the determination that the extended prompt template satisfies the extension rule, activate the extended prompt template for use with the text generation model.

2. The system of claim 1, the one or more processing units to execute the program code to cause the system to:
receive an inference request;
in response to the inference request, populate the extended prompt template to generate an extended prompt;
transmit the extended prompt to the text generation model; and
receive a response from the text generation model.

3. The system of claim 2, wherein the instructions to edit the prompt template comprise instructions to add a parameter to prompt text of the prompt template, and
wherein the inference request includes a value of the parameter.

4. The system of claim 1, wherein the instructions to edit the prompt template comprise instructions to add a parameter to prompt text of the prompt template.

5. The system of claim 4, wherein the instructions to edit the prompt template comprise instructions to add a post-context validation to the prompt template.

6. The system of claim 1, wherein the extension rule conforms to an extension rule schema, the one or more processing units to execute the program code to cause the system to:
identify a second prompt template associated with a second text generation model and conforming to the prompt template schema;
receive second instructions to edit the second prompt template;
in response to the second instructions, generate a second extended prompt template;
determine a second extension rule associated with the second prompt template, wherein the second extension rule conforms to the extension rule schema ;
determine that the second extended prompt template satisfies the second extension rule; and
in response to the determination that the second extended prompt template satisfies the second extension rule, activate the second extended prompt template for use with the second text generation model.

7. The system of claim 1, wherein the extension rule conforms to an extension rule schema and the extended prompt template conforms to the prompt template schema.

8. A method comprising:
identifying a machine-learning scenario;
identifying a text generation model associated with the machine-learning scenario;
identifying a plurality of prompt templates associated with the machine-learning scenario and with the text generation model, each of the plurality of prompt templates conforming to a prompt template schema;
receive instructions to edit a prompt template of the plurality of prompt templates;
in response to the instructions, generate an extended prompt template based on the prompt template;
determine an extension rule associated with the prompt template;
determine that the extended prompt template satisfies the extension rule; and
in response to the determination that the extended prompt template satisfies the extension rule, activate the extended prompt template for use with the text generation model and the machine-learning scenario.

9. The method of claim 8, further comprising:
receiving an inference request;
in response to the inference request, populating the extended prompt template to generate an extended prompt;
transmitting the extended prompt to the text generation model; and
receiving a response from the text generation model.

10. The method of claim 9, wherein the instructions to edit the prompt template comprise instructions to add a parameter to prompt text of the prompt template, and
wherein the inference request includes a value of the parameter.

11. The method of claim 8, wherein the instructions to edit the prompt template comprise instructions to add a parameter to prompt text of the prompt template.

12. The method of claim 11, wherein the instructions to edit the prompt template comprise instructions to add a post-context validation to the prompt template.

13. The method of claim 8, wherein the extension rule conforms to an extension rule schema, the method further comprising:
identifying a second machine-learning scenario;
identifying a second text generation model associated with the second machine-learning scenario;
identifying a second plurality of prompt templates associated with the second machine-learning scenario and with the second text generation model, each of the second plurality of prompt templates conforming to the prompt template schema;
receiving second instructions to edit a second prompt template of the second plurality of prompt templates;
in response to the second instructions, generating a second extended prompt template based on the second prompt template;
determining a second extension rule associated with the second prompt template, the extension rule and the second extension rule conforming to an extension rule schema;
determining that the second extended prompt template satisfies the second extension rule; and
in response to determining that the second extended prompt template satisfies the second extension rule, activating the second extended prompt template for use with the second text generation model and the second machine-learning scenario.

14. One or more non-transitory media storing program code executable by a computing system to cause the computing system to:
identify a prompt template associated with a text generation model and conforming to a prompt template schema;
receive instructions to edit the prompt template;
in response to the instructions, generate an extended prompt template;
determine an extension rule associated with the prompt template;
determine that the extended prompt template satisfies the extension rule; and
in response to the determination that the extended prompt template satisfies the extension rule, activate the extended prompt template for use with the text generation model.

15. The one or more non-transitory media of claim 14, the program code executable by a computing system to cause the computing system to:
receive an inference request;
in response to the inference request, populate the extended prompt template to generate an extended prompt;
transmit the extended prompt to the text generation model; and
receive a response from the text generation model.

16. The one or more non-transitory media of claim 15, wherein the instructions to edit the prompt template comprise instructions to add a parameter to prompt text of the prompt template, and
wherein the inference request includes a value of the parameter.

17. The one or more non-transitory media of claim 14, wherein the instructions to edit the prompt template comprise instructions to add a parameter to prompt text of the prompt template.

18. The one or more non-transitory media of claim 17, wherein the instructions to edit the prompt template comprise instructions to add a post-context validation to the prompt template.

19. The one or more non-transitory media of claim 14, wherein the extension rule conforms to an extension rule schema, the program code executable by a computing system to cause the computing system to:
identify a second prompt template associated with a second text generation model and conforming to the prompt template schema;
receive second instructions to edit the second prompt template;
in response to the second instructions, generate a second extended prompt template;
determine a second extension rule associated with the second prompt template, wherein the second extension rule conforms to the extension rule schema ;
determine that the second extended prompt template satisfies the second extension rule; and
in response to the determination that the second extended prompt template satisfies the second extension rule, activate the second extended prompt template for use with the second text generation model.

20. The one or more non-transitory media of claim 14, wherein the extension rule conforms to an extension rule schema and the extended prompt template conforms to the prompt template schema.
